(19) United States
(12) Patent Application Publication
(10) Pub. No.: US 2018/0372212 A1
(43) Pub. Date: Dec. 27, 2018

(54) GEAR SHIFT LEVER AND METHOD FOR PRODUCING A GEAR SHIFT LEVER

(71) Applicant: ZF Friedrichshafen AG, Friedrichshafen (DE)

(72) Inventor: Holger Peschke, Bohmte (DE)

(73) Assignee: ZF Friedrichshafen AG, Friedrichshafen (DE)

(21) Appl. No.: 16/062,582

(22) PCT Filed: Nov. 15, 2016
(86) PCT No.: PCT/EP2016/077639

§ 371 Date: Jun. 14, 2018

(30) Foreign Application Priority Data
Dec. 16, 2015 (DE) 10 2015 225 494.1

(51) Int. Cl. F16H 59/02

(52) U.S. Cl. CPC F16H 59/0217; F16H 59/10

(57) ABSTRACT

A gearshift lever for selecting a gear ratio of a motor vehicle transmission may include a body formed of an injection molded plastic material. The gearshift lever may further include a component that is at least partially integrated into the gearshift lever via the injection molded plastic material, where the component is at least one of a mechatronic component and a mechanical component.

### CROSS-REFERENCE TO RELATED APPLICATIONS

This application is a filing under 35 U.S.C. § 371 of International Patent Application PCT/EP2016/077639, filed Nov. 15, 2016, and claims the priority of German Patent Application 10 2015 225 494.1, filed Dec. 16, 2015. All applications listed in this paragraph are herein incorporated by reference in their entireties.

### TECHNICAL FIELD

The present disclosure relates to a gearshift lever and a method for producing a gearshift lever for a motor vehicle.

### BACKGROUND

For a gearshift lever, which is used for the shifting of gears in a motor vehicle transmission, electronic components can be attached to base body so that additional functions can be operated via this gearshift lever.

DE 198 01 526 A1 depicts a combined gearshift arrangement for a motor vehicle.

In this context, the present disclosure provides an improved gearshift lever and an improved method for producing a gearshift lever in accordance with the independent claims. Advantageous embodiments can be derived from the dependent claims and from the following description.

### BRIEF SUMMARY

The assembling of electronic components, mechanic components and/or of mechatronic components to a base body requires a lot of work. By using an assembly injection molding procedure, such components can be produced in an automated way by means of a corresponding injection molding tool. This reduces a large portion of the assembling effort. By means of the herein presented approach of a gearshift lever with at least one mechatronic or mechanical component that is connected in a one-piece manner, it is possible to reduce costs and weight. Such a gearshift lever furthermore features a high durability and a low creep tendency. Additionally, a good electrical insolation is provided by means of the use of plastic material. The lower stiffness when compared to metal can be easily compensated by means of constructive adjustments.

A gearshift lever for selecting a gear ratio in a motor vehicle transmission is presented, wherein the gearshift lever features an injection molded plastic material and at least one mechatronic or mechanical component of the gearshift lever which is at least partially integrated into the gearshift lever.

A gearshift lever can be understood to be an operating element that can be operated by a person. The gearshift lever can be referred to as a selector lever. A plastic material can refer to a thermoplastic and/or to a thermoset or to a material mixture. The plastic material can be fiber-reinforced. An integrating can be understood to refer to a one-piece connection.

The component can be a pressure piece, which features at least one locking element that is mounted within the gearshift lever and a spring that is arranged between the locking element and a counter bearing. The counter bearing can be overmolded by the plastic material. The assembling effort can be reduced by means of an overmolding of a pressure piece.

The component may refer to a permanent magnet that is overmolded by means of the plastic material. A mechanically durable connection can be produced by means of an overmolding of a permanent magnet.

The component can be a contacting device in which electrically conductive conducting paths are overmolded by the plastic material. Conducting paths can be integrated into the gearshift lever in the form of leadframes, flex foils, circuit boards or stranded wires. The conducting paths are arranged within the gearshift lever and thus also protected by means of the overmolding of the conducting paths. An outer contour of the gearshift lever can be shaped in a simpler manner. The conducting paths can function as reinforcement elements for the gearshift lever.

The component can include at least one sensor. A sensor may refer to a magnetic field sensor or to a position sensor. The sensor can be contacted via at least partially injection molded conducting paths. Due to the overmolded sensor, it is possible to detect a measured value at a location within the gearshift lever that would overwise be inaccessible.

The component can be a damping element. The damping element can feature an elastic damping material, which is overmolded onto the plastic material by means of injection molding. By means of an overmolding of another material onto the plastic material of the gearshift lever, it is possible to simplify the interface geometry. Due to the overmolding, gaps can be prevented.

The component may include a magnetizable material. The material can be attached to the plastic material by means of the injection molding and be subsequently magnetized. An aligning of the magnetic field can be easily controlled by means of a subsequent magnetizing. Thus, a precise position detection can be achieved by means of magnetic field sensors.

The plastic material can be fiber-reinforced. A high mechanical stability of the gearshift lever can be achieved by means of incorporated fibers, such as glass fiber, carbon fiber or also natural fiber.

The gearshift lever can comprise an inlay that is made of a reinforcement material. The inlay can be overmolded by the plastic material. The reinforcement material may feature a higher stiffness than the plastic material. An inlay can be arranged at such positions of the gearshift lever that are particularly exposed to strain. The inlay may be made of carbon fiber, glass fiber or metal. The inlay can feature a simple geometry.

Furthermore, a method for producing a gearshift lever is presented, wherein the method includes the following steps:

providing of an injection molding tool for the gearshift lever;

injection molding of a plastic material into the injection molding tool, in order to form the gearshift lever; and

integrating of at least one mechatronic or mechanical component of the gearshift lever into the gearshift lever and/or into the injection molding tool, wherein the component is at least partially overmolded by the plastic material in the step of the injection molding, when the component is arranged within the injection molding tool.

### BRIEF DESCRIPTION OF THE DRAWINGS

The present embodiments are explained by means of the attached drawings in more detail in an exemplified manner. It is shown:

FIG. 1 a depiction of a gearshift lever;

FIG. 2 a depiction of a gearshift lever in accordance with an embodiment of the present disclosure;

FIG. 3 a depiction of a gearshift lever with an overmolded pressure piece in accordance with an embodiment of the present disclosure;

FIG. 4 a depiction of a gearshift lever with an overmolded damping material in accordance with an embodiment of the present disclosure;

FIG. 5 a depiction of a gearshift lever with an overmolded gliding material in accordance with an embodiment of the present disclosure;

FIG. 6 a depiction of a gearshift lever with an overmolded magnet in accordance with an embodiment of the present disclosure;

FIG. 7a depiction of a gearshift lever with overmolded conducting paths in accordance with an embodiment of the present disclosure;

FIG. 8 a depiction of a gearshift lever with an overmolded sensor in accordance with an embodiment of the present disclosure;

FIG. 9a depiction of a gearshift lever with overmolded electrical circuits in accordance with an embodiment of the present disclosure;

FIG. 10 a depiction of a gearshift lever in accordance with an embodiment of the present disclosure with a cardan joint;

FIG. 11 a depiction of a gearshift lever in accordance with an embodiment of the present disclosure with a ball joint;

FIG. 12 a depiction of a gearshift lever in accordance with an embodiment of the present disclosure with an overmolded component;

FIG. 13 a depiction of a gearshift lever in accordance with an embodiment of the present disclosure with an overmolded spherical calotte; and

FIG. 14 a flow chart of a method for producing a gearshift lever in accordance with an embodiment of the present disclosure.

### DETAILED DESCRIPTION

In the following description of preferred embodiments of the present disclosure, identical or similar reference signs are used for the elements that are shown in the various figures, which function in a similar way, wherein a repeated description of these elements is omitted.

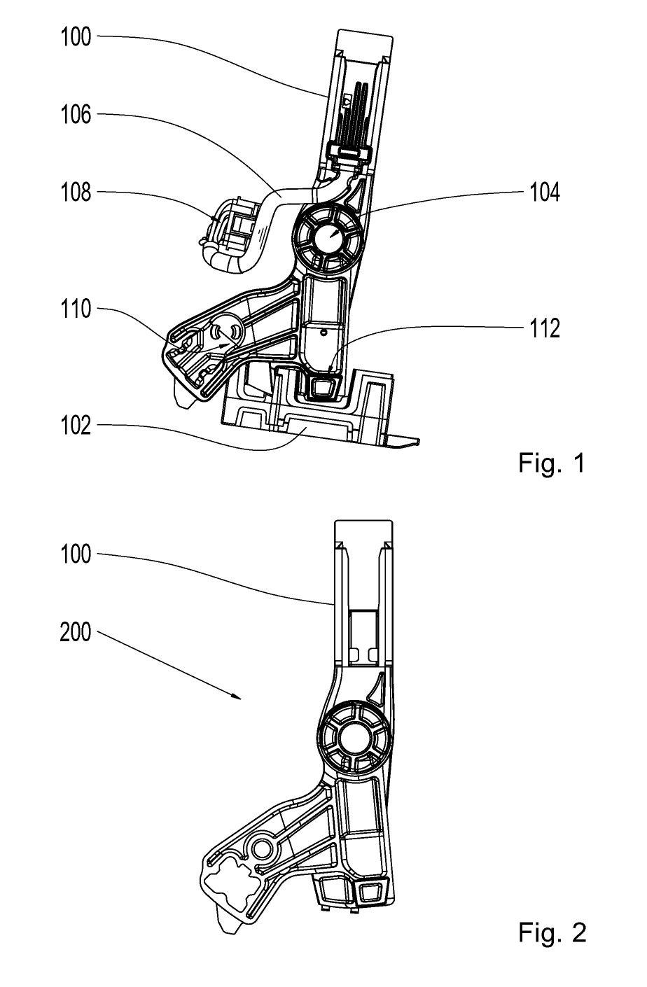

FIG. 1 shows a depiction of a common gearshift lever 100. Gearshift lever 100 is designed to be used as operating element for selecting a gear in a transmission of a motor vehicle. Gearshift lever 100 is therefore arranged within a suitable housing 102. Only a section of housing 102 is depicted. Gearshift lever 100 is mounted within housing 102 so that it can be rotated around a pivot point 104. It is possible to arrange a not depicted knob holder at one end that is protruding out of housing 102.

Gearshift lever 100 may be arranged within a motor vehicle in the area of the center console. Thus far, such a gearshift lever 100 is made up of a selector control that is made of metal materials such as of steel, aluminum and/or zinc die casting. Mechanical and mechatronic sub-systems are only integrated into gearshift lever 100 by means of additional components and assembling procedures.

In other words, FIG. 1 depicts the actual state of a gearshift lever 100 up to now. Gearshift lever 100 may be made of zinc die casting (ZP05) and may feature a weight of about 161 g. Gearshift lever 100 features a plug-in contour for the knob and a cable 106 with a plug 108. An element 110 for a limit stop damping (PA66GF30) has been subsequently attached to gearshift lever 100. Furthermore, a locking element 112 that is made up of three individual components, a ring (PA66) and a pressure spring have been subsequently attached to gearshift lever 100 (PA66 o. POM). The locking element engages into a locking arrangement (PA66+soft component) of housing 102.

Gearshift lever 100 of a selector control is a component for choosing a gear ratio in a motor vehicle transmission and thus far it is made of metal materials and in accordance with the herein presented approach, it is substituted by means of a gearshift lever that is made of a thermoplastic with short-glass fiber, long-glass fiber or also with a thermoset material.

All integrated sub-systems feature different advantages in their use and can be combined with each other according to necessity. Costs and weight of the component are reduced, and the functional variety is increased.

FIG. 2 shows a depiction of a gearshift lever 100 in accordance with an embodiment of the present disclosure. Gearshift lever 100 essentially corresponds to the gearshift lever in FIG. 1. In contrast to that one, the herein presented gearshift lever is made of a plastic material that is processed in an injection molding procedure and is thus significantly lighter than the metal gearshift lever in FIG. 1. Since gearshift lever 100 is manufactured from plastic material, mechatronic and mechanical sub-systems 200 can be integrated in the assembly injection molding process. A sub-system 200 can be referred to as component.

Thermoplastics or thermoplastic materials with short-glass fibers, long-glass fibers, carbon fibers or also thermosets or thermoset materials can be used for a plastic gearshift lever 100. For example, the herein used plastic material features a density of 1770 kg/m³, an E-Modul of 25000 MPa, a breaking tension of 280 MPa and a breaking strain of 1.9%. Thus, gearshift lever 100 may have a weight of about 43 g.

Gearshift lever 100 is mounted within the gear shifting system by means of a ball or cardan joint in the gearshift housings. The ball can be designed with or also without a ball socket and the cardan joint can be called a cross piece.

Gearshift lever 100 is optimized in a constructive manner with regard to its durability and stiffness in that grooves are minimized, locking contours are configured with a material thickening, an overall material thickening is included to increase the geometrical moment of inertia and the rib structure is changed. For example, gearshift lever 100 features a wall thickness of 2.5 mm to 3 mm.

Gearshift lever 100 can be produced from a thermoplastic material with glass fibers (short-glass fibers GF/long-glass fibers LGF) or also carbon fibers (CF) by means of the injection molding procedure. Another variant is to manufacture the gearshift lever from thermoset. Due to the use of plastic material, the component is electrically insulated.

If the stiffness of the used thermoplastics with short-glass or also long-glass fibers is not sufficient, an increase of the durability can be achieved in partial component sections. Steel inlays or also carbon fiber stripes can be used as inlays. The inlays are overmolded with the plastic material. This results in a greater stiffness of the unit. The steel inlays can be designed with a simple geometry. These reinforcements can be overmolded with a specific alignment of the fibers. Reinforcements can be used in the area with a maximum strain in the direction of the main deformation.

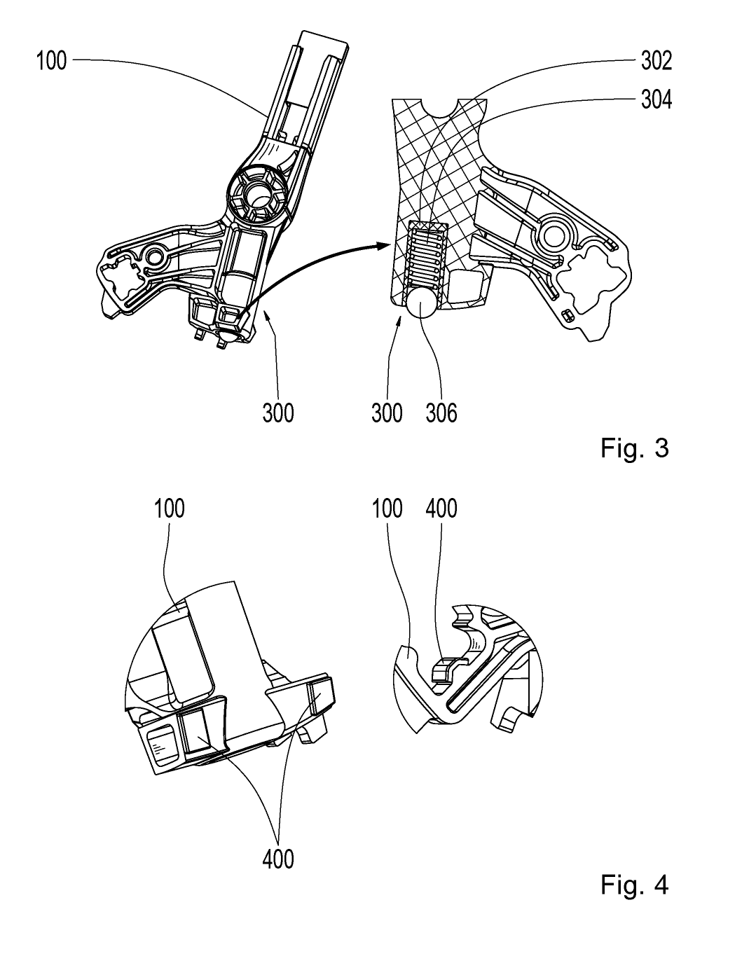

FIG. 3 shows a depiction of a gearshift lever 100 with an overmolded pressure piece 300 in accordance with an embodiment of the present disclosure. Gearshift lever 100 essentially corresponds to the gearshift lever in FIG. 2. As in FIG. 1, the pressure piece 300 is herein additionally embedded into the injection molded plastic on the end of gearshift lever 100 that is facing away from the knob. Pressure piece 300 was thus inserted into the injection molding tool before the injection molding process. During the injection molding process, pressure piece 300 is held within the injection molding tool on its designated location by means of a positioning device, while the injection molding tool is filled with plastic material.

Pressure piece 300 is shown in a detailed depiction. The pressure piece 300 features a cup-shaped shell 302 in which a pressure spring 304 is arranged. Pressure spring 304 rests on a base of shell 302 and pushes a locking element 306 into a locking position at the open end of shell 302. In this example, locking element 306 is a ball. Locking element 306 can also be designed as a locking pin.

Conventionally, locking systems usually consist of two components, such as pin 306 and pressure spring 304 and are subsequently installed at a base body of the gearshift lever.

A plastic material gearshift lever 100 with an embedded spring-loaded pressure piece 300 is depicted, which is overmolded in the assembly injection molding process as an inlay made of the above-mentioned plastic material types. Pressure piece 300, which is to be overmolded, comprises a ball or a pin 306, a pressure spring 304 and a shell 302 that is made of steel or plastic. Gearshift lever 100 with the integrated spring-loaded pressure piece 300 forms a part of the locking systems in the shifting arrangement.

The plastic material gearshift lever 100 with pressure piece 300 allows for a miniaturization of shifting arrangements. In other words, much smaller shifting arrangements can be implemented. The overmolding of pressure piece 300 minimizes tolerances in the overall system and elasticities of the locking system. It furthermore results in an improvement of the hysteresis or friction characteristics in the locking system. The assembling effort is eliminated or reduced. In an ideal case, no lubrication will be needed. The herein depicted plastic material gearshift lever 100 features improved acoustic characteristics.

The plastic material gearshift lever 100 can furthermore also be additionally used along with the locking system comprising the pressure spring and locking pin.

The pressure piece can be overmolded or ball 306 can be pressed into the bore hole after the injection molding procedure. This results in a minimizing of the tolerances, a minimizing of the elasticities, an improvement of the hysteresis due to rolling friction, a cost reduction due to the reduction from three components to one component, since an assembling can be omitted. It is furthermore possible that a lubrication of the bearing location between pressure piece 300 and the locking arrangement is omitted and significantly smaller shifting arrangements can be implemented. The locking arrangement can be realized within the housing without any additional component.

In one embodiment, the locking system comprising pressure spring 304 and ball 306 is pressed or thermoformed in succession of the injection molding process, so that gearshift lever 100 and the locking system form one unit.

In an embodiment that is not depicted, a locking magnet is integrated into gearshift lever 100. The locking contour is depicted in the housing.

FIG. 4 shows a depiction of a gearshift lever 100 with an injection molded damping material 400 in accordance with an embodiment of the present disclosure. Gearshift lever 100 essentially corresponds to the gearshift lever in FIG. 2. Two partial sections of gearshift lever 100 are depicted. Additionally, the damping material 400 is herein arranged at the limit stop surfaces of gearshift lever 100. Damping material 400 is an elastic material, which has been attached to the plastic material of gearshift lever 100 by means of injection molding. To accomplish this, it is possible to take gearshift lever 100 out of the first injection molding tool after the first injection molding procedure and to place it in a second injection molding tool, which has pockets for the damping material 400. The damping material 400 is injected into these pockets in an injection molding procedure.

Elements 400 for noise reduction are usually produced as individual components and are then subsequently attached to the base body.

In accordance with an embodiment, a plastic material gearshift lever 100 with overmolded damping elements 400 is depicted in FIG. 4. By means of the assembly injection molding process it is possible to equip sections with a thermoplastic elastomer, which will function in the system assembly as end stop damping elements or limit stop damping elements for locking systems, such as for a lifting magnet. Acoustically noticeable impact noises are minimized in this way. Bearing locations can be overmolded with a second component in the 2k-process in such a way, that a vibration damping is achieved in the area of the bearing.

By means of this assembling procedure, it is possible to achieve cost advantages when compared to a damping via a sealing ring and an acoustic improvement in the limit stops or the bearing.

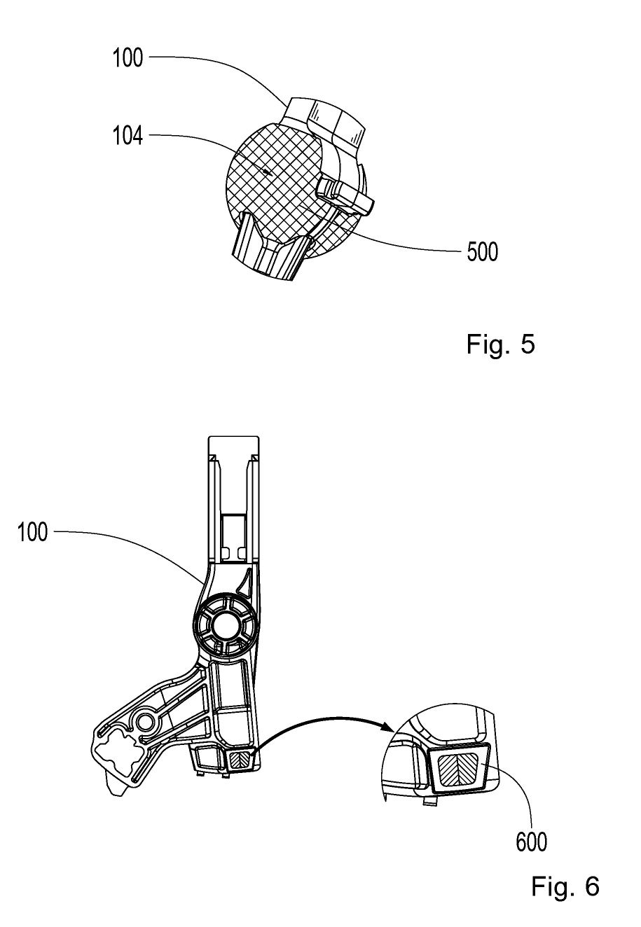

FIG. 5 shows a depiction of a gearshift lever 100 with an overmolded sliding material 500 in accordance with an embodiment of the present disclosure. Gearshift lever 100 essentially corresponds to the gearshift lever in FIG. 2. As it is the case in FIG. 4, the plastic material of gearshift lever 100 is overmolded with an additional material 500. Gliding material 500 features a low friction coefficient. It is thus possible to achieve low friction in a bearing location of gearshift lever 100.

Gliding material 500 is herein arranged at bearing location 104. Bearing location 104 is designed as ball joint. Gliding material 500 forms a gliding layer of the ball joint. Gliding material 500 can be used for a bearing damping and/or for a vibration damping.

FIG. 6 shows a depiction of a gearshift lever 100 with an overmolded magnet 600 in accordance with an embodiment of the present disclosure. Gearshift lever 100 essentially corresponds to the gearshift lever in FIG. 2. Additionally, magnet 600 is herein integrated into the plastic material of gearshift lever 100 on the end of gearshift lever 100 that is facing away from the knob. Just like the pressure piece 300 in FIG. 3, magnet 600 is inserted into the injection molding tool before the injection molding process and fixed to its position during the injection molding process, while it is encased by the plastic material.

In one embodiment, magnet 600 is manufactured in a magnetizing procedure that follows the injection molding process by means of a magnetizable material which is injected into gearshift lever 100. To accomplish this, gearshift lever 100 has been placed into an injection molding tool comprising a pocket for the magnetizable material after the injection molding process with the plastic material, just like in FIGS. 4 and 5. Subsequently, the magnetizable material has been injected into the pocket. During the magnetizing procedure, a strong external magnetic field is directed onto the magnetizable material, by means of which the magnetizable material is magnetized and forms the magnet 600 itself.

The permanent magnet 600 is herein attached to gearshift lever 100 without any additional components. In other words, the permanent magnet 600 or also components 600, into which the magnetic field is magnetized in a subsequent procedure, is directly connected to gearshift lever 100.

An embedding of permanent magnets 600 and/or of magnetizable components 600 for a detection of the position of gearshift lever 100 by means of sensors within the shifting system is depicted.

Pressed plastic bonded or injection molded magnets and sintered magnets 600 can be overmolded in the injection molding process into partial sections of gearshift lever 100. It is also possible to inject a magnetizable components into the gearshift lever base body by means of the 2k-process. In a subsequent procedure the magnetic field will be magnetized. The detection of the positions within the gearshift lever in the shifting system is carried out by means of Hall or also 3D sensors.

A mechanical gliding system can thus be left out and the assembly is not necessary. The result is a minimizing of the mechanical tolerances as well as a minimizing of the electrical tolerances. Furthermore, a minimizing of the magnetic tolerances is achieved by means of a later application of the magnetic field, resulting in a minimization of the angular error.

In other words, an integrating of permanent magnet 600 for a detection of the position by means of Hall sensors or 3D sensors is realized by means of an overmolding or an attachment by means of clips. The permanent magnet can also be designed as a 2k-section with magnetizable plastic materials 600. A gliding system can thereby be left out, tolerances can be minimized, and an additional assembly is no longer necessary. To accomplish this, sintered magnets 600, pressed plastic material bound magnets 600 and/or plastic material bound injected magnets can be used.

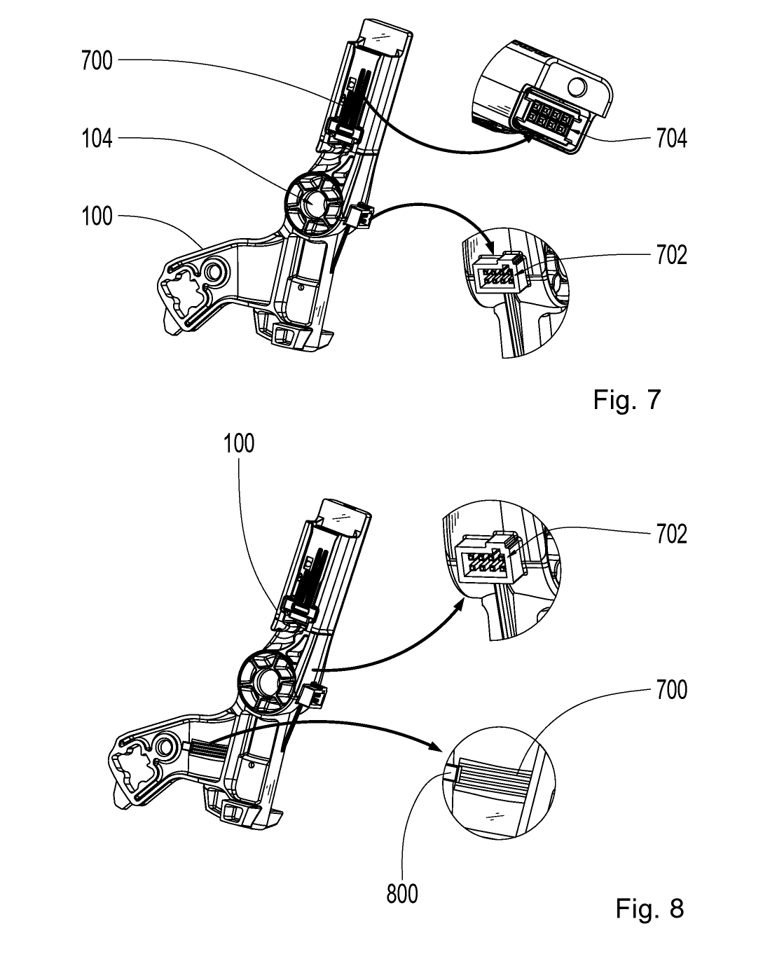

FIG. 7 shows a depiction of a gearshift lever 100 with overmolded conducting paths 700 in accordance with an embodiment of the present disclosure. Gearshift lever 100 essentially corresponds to the gearshift lever in FIG. 2. Additionally, the conducting paths 700 are herein arranged at least partially within the plastic material of gearshift lever 100. The conducting paths 700 connect a first plug 702 in the area of bearing location 104 and a second plug 704 in the area of an interface towards the knob.

The conducting paths 700 and the plugs 702, 704 have been allocated within the injection molding tool before the injection molding procedure and are at least partially enclosed by plastic material during the injection molding process.

It is possible to describe conducting paths 700 as knob connectors and they are an integrated sub-system comprising overmolded conducting paths 700 or flex foils and/or leadframes.

The embedding or overmolding of conducting paths 700, the contacting elements 702, 702, the plug contours and/or pins 702, 704 for an electronic contacting of gearshift lever 100 with the knob are depicted. The contacting elements 702, 702 can be referred to as knob interface. These contacting elements 702, 702 can be designed as a pin contact strip for the contacting to the knob. Flex foils, leadframes and contact pins can be used as conducting paths 700. The mentioned components are overmolded during the assembly injection molding process and are thus integrated as mechatronic sub-system in gearshift lever 100. By means of the overmolding, conducting paths 700 are located in a protected manner within the component and/or with the neutral fiber. Thus, no cable on the outside is required. The interface contour 704 for the electronic contacting of the knob is integrated in gearshift lever 100. It is furthermore possible to include grooves, domes, brackets and flattened portions, which are used for the attachment of a flex foil, in case it may not be overmolded due to space reasons. The counter contacting 702 towards the circuit board is placed in an area, which is secured from environmental influences within the shifting arrangement and which allows for only little movement.

Since the cables 700 or the flex foil is no longer located outside of the shifting arrangement, it is secured against damaging. Elements for the attachment or protection of flex foils or of cables are no longer necessary, which results in a reduction of components. The assembling procedure is no longer required and gearshift lever 100 features less components.

FIG. 8 shows a depiction of a gearshift lever 100 with an overmolded sensor 800 in accordance with an embodiment of the present disclosure. Gearshift lever 100 essentially corresponds to the gearshift lever in FIG. 7. The sensor 800 is herein additionally connected to partially overmolded conducting paths 700.

Sensor 800 can refer to, for example, a Hall sensor 800 or a 3D sensor 800 or another type of sensor. Sensor 800 is arranged in an area of the gearshift lever base body 100 that is free of strain. Thus, tolerances can be minimized, and gliding components can be omitted.

The gearshift lever 100 with the integrated sensor arrangement 800 is realized by means of the assembly injection molding process.

An integration of the sensors 800 into gearshift lever 100 is depicted. The sensors 800 are hereby placed on populated leadframes or flex foils 700. These mechatronic components 700, 800 are overmolded completely or only in partial areas by means of the assembly injection molding process. The magnets needed for the sensing when using Hall sensors 900 can be located within the housing. Just as it is the case in FIG. 6, the magnets can either be clipped in or overmolded in the 2k-process or injection molded. The sensors 800 in the gearshift lever can also be arranged in accordance with the MID technology (Molded Interconnect Devices). Sensor 800 can be contacted via the electronic interface 702.

By means of an integration of sensors 800 into gearshift lever 100, tolerances can be minimized, gliding components are no longer necessary, and the circuit board can be placed at any desired location within the shifting system. The necessary installation space for the shifting system is also reduced.

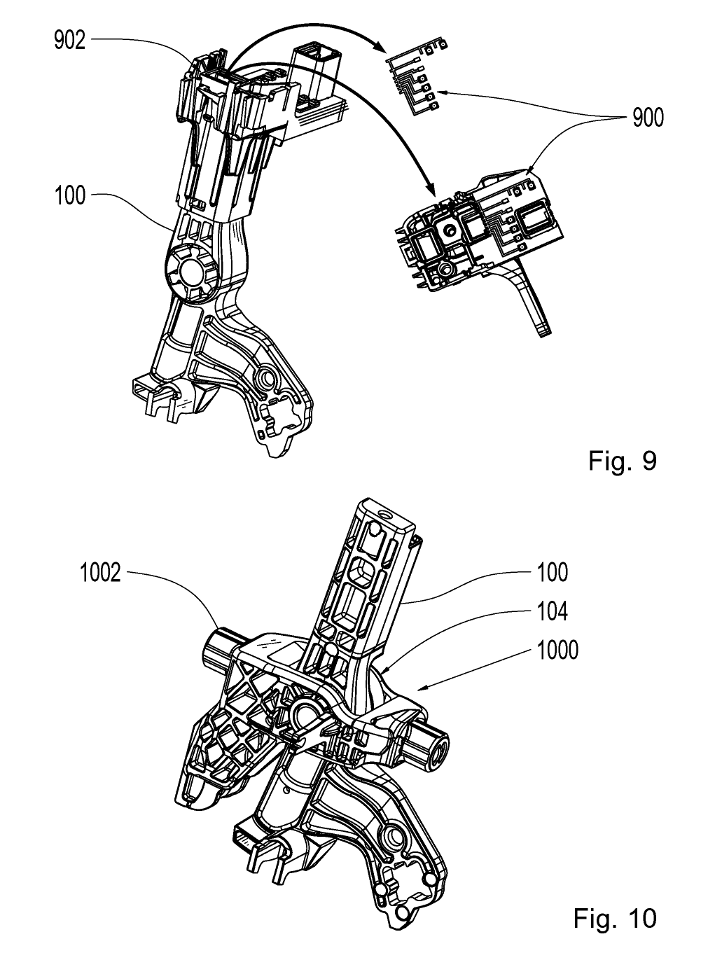

FIG. 9 shows a depiction of a gearshift lever 100 with overmolded electrical circuits 900 in accordance with an embodiment of the present disclosure. Gearshift lever 100 essentially corresponds to the gearshift lever in FIG. 7. Additionally, a knob holder 902 is injection molded onto gearshift lever 100. Two electrical circuits 900 are integrated into the knob holder 902. A light diode driver and a corresponding light diode arrangement are integrated into the knob holder 902 in this embodiment.

The electrical circuits 900 can be supplied with electrical energy by means of electrical conductors that are integrated into the gearshift lever 100.

In other words, a gearshift lever 100 is depicted comprising an integrated knob holder 902, which includes electrical components 900 such as buttons, light conductors, circuit boards or the like. For example, LED light technology can be integrated by means of populated leadframes into key holder 902.

In the herein presented approach, a substitution of metal components and an integration of mechatronic and mechanical sub-systems is carried out by means of the assembly injection molding procedure into gearshift lever 100. For example, spring-loaded pressure pieces, damping soft components, unpopulated and populated leadframes and flex foils, sections with magnetizable materials and the MID technology is used as mechanical and mechatronic sub-systems.

It is furthermore possible to integrate technologies for attaching such as locking hooks, domes, locking counter geometries and/or bore holes for holding and partially attaching of mounting parts such as gearshift lever knob, permanent magnet, plug interfaces, flex foils.

In this way, there is a transformation from a mechanical into a mechatronic component.

FIG. 10 shows a depiction of a gearshift lever 100 in accordance with an embodiment of the present disclosure with a cardan joint 1000. Gearshift lever 100 essentially corresponds to the gearshift lever in FIG. 2. In this example, gearshift lever 100 is connected with a cross piece 1002 in pivot point 104. Gearshift lever 100 is mounted in the cross piece 1002 in such a manner that it can be rotated around a first axis. The cross piece 1002 is mounted in the not depicted housing in such a manner that it can rotate around a second axis which is aligned orthogonally to this axis. Thus, the gearshift lever 100 is mounted in such a way within the housing, that it can be moved around two axes.

The cross piece 1002 is also designed as a plastic injection molded component.

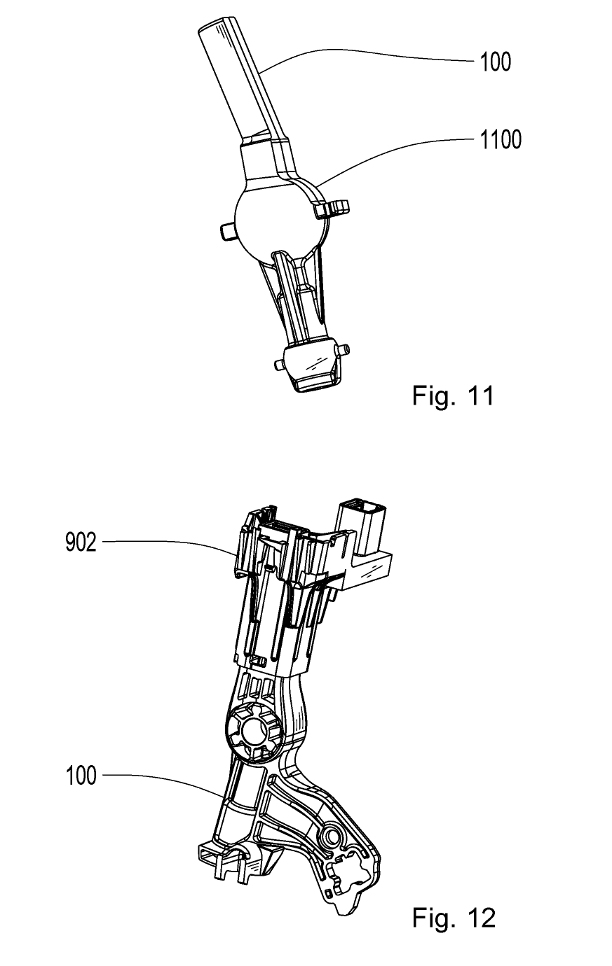

FIG. 11 shows a depiction of a gearshift lever 100 in accordance with an embodiment of the present disclosure with a ball joint 1100. Gearshift lever 100 essentially corresponds to the gearshift lever in FIG. 5. Gearshift lever 100 is implemented as a plastic injection molded component with an overmolded ball 1100. The ball 1100 is at least partially implemented with a flattened portion, since the intended range of motion of gearshift lever 100 does not require a complete ball-shape.

It is possible to mount selector lever 100 by means of a ball 1100 or a cardan joint or cross piece 1002 within the housing or between the housing halves. If necessary, the bearing locations can be overmolded with a second plastic component in order to improve the tribological as well as also the acoustic characteristics.

FIG. 12 shows a depiction of a gearshift lever 100 in accordance with an embodiment of the present disclosure with an overmolded component 902. Gearshift lever 100 essentially corresponds to the gearshift lever in FIG. 9. As it was the case in FIG. 9, a knob holder 902 is injection molded onto the gearshift lever 100. To accomplish this, the injection molding tool of gearshift lever 100 is redesigned and expanded to include the geometry of the knob holder 902. In this way it is possible to reduce assembling procedures.

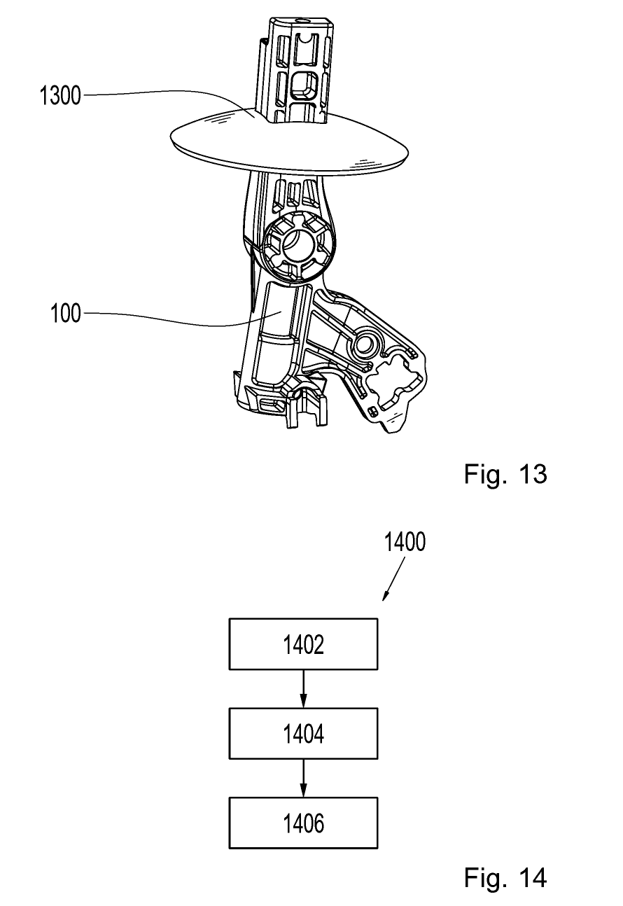

FIG. 13 shows a depiction of a gearshift lever 100 in accordance with an embodiment of the present disclosure with an overmolded spherical calotte 1300. As it was the case in FIG. 12, the injection molding tool of gearshift lever 100 is redesigned and expanded to include the geometry of the spherical calotte 1300. The spherical calotte 1300 is thus connected to gearshift lever 100 in a one-piece manner.

In the FIGS. 2 to 13, a gearshift lever 100 that made of plastic is presented, with integrated mechanical and mechatronic sub-systems for shifting operations in motor vehicles. By means of the herein presented approach a transformation is made from a mechanical into a mechatronic component.

Due to the production of the gearshift lever 100 by means of plastic material, the possibility is provided to produce interface components such as knob holders 902 or key holders for the holding of knob mounting parts, and calottes 1300 for the protection of the shifting arrangement against and entry of objects, in a one-piece manner. The component can be produced from one material or also from several materials by means of the injection molding procedure.

Gearshift lever 100 thus comprises less components and a lower assembling effort as well as a lower effort for an interface adjusting is achieved.

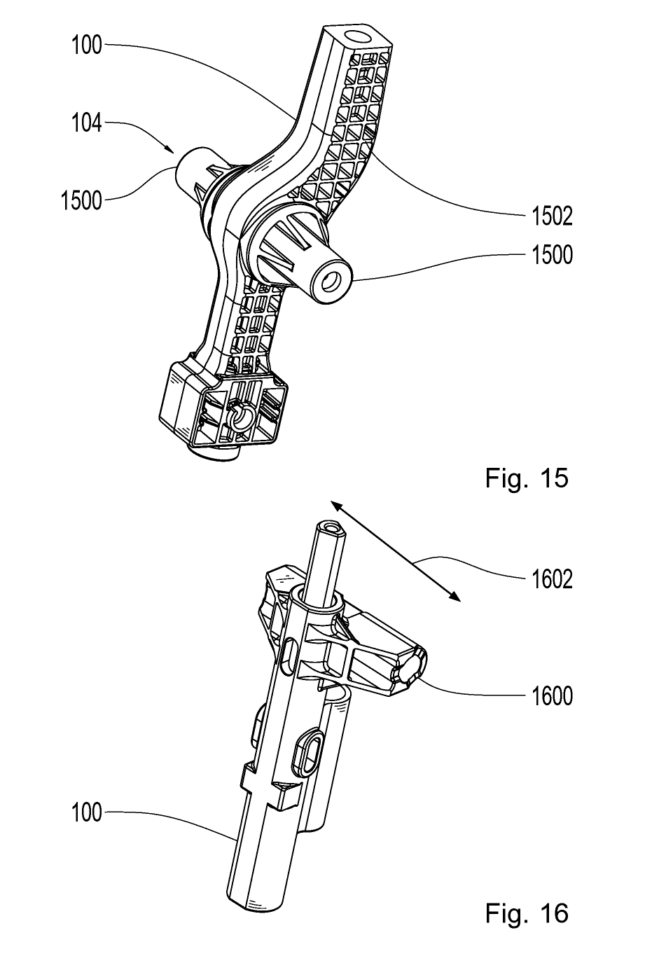

FIG. 14 shows a flow chart of a method 1400 for producing a gearshift lever in accordance with an embodiment of the present disclosure. The method 1400 includes a step 1402 of providing, a step 1404 of injection molding, and a step 1406 of integrating. In step 1402 of providing, an injection molding tool for the gearshift lever is provided. In step 1404 of injection molding, a plastic material is injected into the injection molding tool in order to form the gearshift lever. In step 1406 of integrating, at least one mechatronic or mechanical component of the gearshift lever is integrated into the gearshift lever and/or into the injection molding tool. When the component is aligned within the injection molding tool, it is at least partially overmolded by means of the plastic material in step 1404. When the component is connected to the plastic material, the gearshift lever is taken out of a first injection molding tool and placed into a second injection molding tool and a further plastic material is injected into additional pockets of the second injection molding tool.

If an embodiment includes an “and/or” link between a first characteristic and a second characteristic, this can be understood in such a way that the embodiment in accordance with one design form features both, the first characteristic as well as the second characteristic and in accordance with a further design form either only the first characteristic or only the second characteristic.

### LIST OF REFERENCE SIGNS

100 Gearshift lever
102 Housing
104 Pivot point
106 Cable
108 Plug
110 Limit stop damper
112 Locking element
200 Component
300 Pressure piece
302 Shell
304 Pressure spring
306 Locking element
400 Damping material
500 Gliding material
600 Magnet
700 Conducting paths
702 Plug
704 Plug
800 Sensor
900 Electrical circuit
902 Knob holder
1000 Cardan joint
1002 Cross piece
1100 Ball joint
1300 Calotte
1400 Method for producing
1402 Step of providing
1404 Step of injection molding
1406 Step of integrating

1. A gearshift lever for selecting a gear ratio of a motor vehicle transmission, the gearshift lever comprising:
a body formed of an injection molded plastic material; and
a component that is at least partially integrated into the gearshift lever via the injection molded plastic material, wherein the component is at least one of a mechatronic component and a mechanical component.

2. The gearshift lever according to claim 1, wherein the component is a pressure piece including at least one locking element that is mounted within the body of the gearshift lever and a spring that is arranged between the locking element and a counter bearing, wherein the counter bearing is overmolded by the plastic material.

3. The gearshift lever according to claim 1, wherein the component is a magnet that is overmolded by the plastic material.

4. The gearshift lever according to claim 1, wherein the component includes electrically conductive paths that are overmolded by the plastic material.

5. The gearshift lever according to claim 4, wherein the component includes at least one sensor.

6. The gearshift lever according to claim 1, wherein the component is a damping element, and wherein the damping element includes an elastic damping material that is overmolded onto the plastic material by an injection molding procedure.

7. The gearshift lever according to claim 1, wherein the component includes a magnetizable material, wherein the magnetizable material is attached to the plastic material by injection molding procedure.

8. The gearshift lever according to claim 1, wherein the injection molded plastic material is fiber-reinforced.

9. The gearshift lever according to claim 1, further comprising an inlay made of a reinforcement material, wherein the inlay is overmolded by the plastic material and the reinforcement material includes a higher stiffness than the plastic material.

10. A method for producing a gearshift lever, the method comprising the following steps:
injection molding of a plastic material into an injection molding tool to form a body of the gearshift lever; and
integrating at least one component of the gearshift lever into the body of the gearshift lever with the injection molding tool, wherein the component is at least one of a mechatronic component and a mechanical component.

11. The method of claim 10, wherein the component is aligned within the injection molding tool such that it is at least partially overmolded by the body of the gearshift lever during the step of injection molding.

12. The method claim 10, wherein the component is a pressure piece including at least one locking element that is mounted within the body of the gearshift lever and a spring that is arranged between the locking element and a counter bearing.

13. The method of claim 12, further comprising overmolding the counter bearing during the injection molding process.

14. The method of claim 10, wherein the component is a magnet.

15. The method of claim 10, wherein the component includes electrically conductive paths that are overmolded by the plastic material.

16. The method of claim 15, wherein the component includes at least one sensor.

17. The method of claim 10, wherein the component is a damping element, and wherein the damping element includes an elastic damping material that is overmolded onto the plastic material by an injection molding process.

18. The method of claim 10, wherein the component includes a magnetizable material.

19. The method of claim 18, further comprising magnetizing the magnetizable material.

20. The method of claim 10, wherein the injection molded plastic material is fiber-reinforced.
